(19) United States
(12) Patent Application Publication
(10) Pub. No.: US 2023/0172784 A1
(43) Pub. Date: Jun. 8, 2023

(54) SYSTEM & METHOD FOR PROVIDING WHOLE BODY VIBRATION THERAPY AND PHYSIOTHERAPEUTIC SPINAL MOBILIZATION AND DECOMPRESSION MODALITIES

(71) Applicant: NORTH AMERICAN MEDICAL CORPORATION, Marietta, GA (US)

(72) Inventors: Gidgette Becerra Rubin, Atlanta, GA (US); Carlos Becerra, Marietta, GA (US); Carlos Mario De Carro, Cartagena (CO)

(21) Appl. No.: 18/074,207

(22) Filed: Dec. 2, 2022

Related U.S. Application Data
(60) Provisional application No. 63/285,125, filed on Dec. 2, 2021.

(51) Int. Cl. A61H 1/00; A61H 1/02

(52) U.S. Cl. CPC A61H 1/005; A61H 1/0222; A61H 2201/164; A61H 2203/0481; A61H 2201/0192; A61H 2201/1652; A61H 2201/1621; A61H 2201/163; A61H 2205/081; A61H 2201/1604

(57) ABSTRACT

Presently provided is a method and system for providing whole body vibration therapy to a patient. The system has a table configured to hold a patient and a vibrational footplate extending outwardly from a foot of the table. The vibrational footplate is configured and disposed to vibrate and to provide whole body vibration to the patient upon the patient placing their feet thereon. An actuator is configured and disposed to adjust an inclination of the table to provide varying degrees of whole body vibration therapy to the patient. The method comprises providing whole body vibration sessions with varying degrees of whole body vibration therapy.

### CROSS REFERENCE TO RELATED APPLICATIONS

This application claims priority to U.S. provisional application No. 63/285,125, filed Dec. 2, 2021, the disclosure of which is hereby incorporated by reference in its entirety.

### FIELD OF INVENTION

The present invention relates to systems and methods for providing spinal linear whole body vibration therapy and mobilization and decompression modalities.

### BACKGROUND OF THE INVENTION

Whole body vibration, WBV, therapy has been clinically shown to stimulate bone growth, aid in osteocyte regeneration, cellular tissue rejuvenation, increase muscle tone in the lower extremities, and help to improve stability and core strengthening. To perform maximum benefit, WBV may be optimally administered via a vibrating plate on which the patient stands. Treatments may take up to 30 minutes per session. These treatments may cause patients to develop dizziness, motion sickness and other equilibrium side effects which may lead to hazards for the patients.

Physiotherapeutic spinal mobilization and decompression modalities may be performed by applying a pulling force to the lumbar vertebrae for producing a decompression reduction and stabilization of the lumbar spine for the treatment of low back pain. For example, a pulling force may be isolated to the lumbar spine by anchoring the upper body while applying a pulling force to the lower body at preselected angles to the axis of the spine.

### SUMMARY

In one aspect of the present disclosure, a method of providing whole body vibration therapy to a patient is provided. The method comprises: standing the patient on a vibrational footplate extending outward from an inclined table; reclining the table toward a horizontal orientation and stopping the reclining of the table at an angle (a) above horizontal; activating the vibrational footplate and providing whole body vibration to the patient at a first vibrational frequency and for a first period of time; returning the table to the substantially inclined orientation; removing the patient from the vibrational footplate; resting the patient for a period of time; standing the patient back onto the vibrational footplate; reclining the table toward the horizontal orientation and stopping the reclining of the table at an angle (b) above horizontal; activating the vibrational footplate and providing whole body vibration to the patient at a second vibrational frequency and for a second period of time; returning the table to the inclined orientation; and removing the patient from the vibrational footplate.

In another aspect of the present disclosure, a whole body vibration and spinal decompression system is provided. The system comprises a table configured to hold a patient and a vibrational footplate extending from a foot of the table and outwardly from a plane of the table at an angle between about 90 degrees and about 170 degrees. The vibrational footplate is configured and disposed to vibrate and to provide whole body vibration to the patient upon the patient placing their feet thereon. An actuator is configured and disposed to adjust an inclination of the table. A belt, upper body harness, or other device is configured and disposed to hold a torso of the patient with respect to the table and a pelvic harness is configured and disposed to hold a pelvis of the patient. A decompression head is configured and disposed to apply tension to the pelvic harness, and thereby the spine of the patient, and decompress the patient's spine.

In a further aspect of the present disclosure, a whole body vibration system is provided. The whole body vibration system has a table configured to hold a patient and a vibrational footplate extending from a foot of the table and outwardly from a plane of the table at an angle between about 90 degrees and about 170 degrees. The vibrational footplate is configured and disposed to vibrate and to provide whole body vibration to the patient upon the patient placing their feet thereon. The system has an actuator configured and disposed to adjust an inclination of the table.

### BRIEF DESCRIPTION OF THE DRAWINGS

The foregoing and other features of this disclosure will become more fully apparent from the following description and appended claims, taken in conjunction with the accompanying drawings and examples. Understanding that these drawings depict only several embodiments in accordance with the disclosure and are therefore, not to be considered limiting of its scope, the disclosure will be described with additional specificity and detail through use of the accompanying drawings.

The following figures, which are idealized, are not to scale and are intended to be merely illustrative of aspects of the present disclosure and non-limiting. In the drawings, like elements may be depicted by like reference numerals. The drawings are briefly described as follows:

FIG. 1 shows an illustrative example of the presently disclosed system for providing linear whole body vibration therapy having a table in a horizontal orientation;

FIG. 2 shows the illustrative example shown in FIG. 1 having the table in a first inclined orientation;

FIG. 3 shows the illustrative example shown in FIG. 1 having the table in a second inclined orientation;

FIG. 4 shows the illustrative example shown in FIG. 1 having the table in a substantially fully inclined orientation;

FIG. 5 shows an illustrative example of system controls that may be disposed with the system shown in FIG. 1; and

FIG. 6 shows an illustrative example of the presently disclosed system for providing linear whole body vibration therapy and decompression modalities.

### DETAILED DESCRIPTION OF THE INVENTION

The present disclosure provides a system and method for providing whole body vibration, WBV, to a patient. Whole body vibration, WBV, is a therapy that involves specific vibrational frequencies to be administered to the musculoskeletal system. For example, vibration frequencies may be between about 25 Hz and 50 Hz, higher or lower. The present disclosure provides for a system and method for applying linear whole body vibration therapy through the soles of the feet of a patient. The system may also provide for decompression modalities, muscular elongation, spinal mobilization and other therapies. For example, the system may have a split-table design that separates about the patient's spine to facilitate decompression modalities, muscular elongation, spinal mobilization and other therapies while also providing WBV therapy.

Prior WBV treatment system and methods may cause patients to develop dizziness and other equilibrium side effects, which may lead to hazards for the patients. For example, in the case of patients with a compromised disc, standing on a vibrating platform could present some safety problems, discomfort, or the patient may simply be physically unable to stand upright to receive whole body vibration therapy.

The presently disclosed system and method for providing spinal mobilization and decompression modalities with linear whole body vibration therapy incorporates the vibrational frequency plate at the foot of a table. This configuration may allow a clinician to administer the WBV treatment safely. In at least one embodiment, the presently disclosed system provides for decompression to spinal disk during WBV treatment and delivery of vibrational frequencies to the whole muscular skeleton system, via WBV, in a manner that substantially eliminates the risk of the patient falling.

The presently disclosed system and method may provide for patients who are physically unable to climb up on the table to receive WBV treatment or therapy. For example, a patient may simply step onto a loading platform, or vibrational plate, which is held at the foot of the table, when the table is in an inclined orientation. The table may then be reclined at varying degrees between upright and horizontal. For example, the degree of gravitational weight placed on the patient may be relative to the inclined positioning of the table. Therefore, there may be a higher degree of therapeutic intensity of WBV with a higher degree of inclination of the table. For example, when receiving WBV in the full horizontal position of the table, the intensity of WBV is relatively low. As the angle of the patient and table is increased, the gravitational force of the patient on a vibrating plate, or vibrational plate, is increased, thus increasing the intensity of the WBV. For example, positioning of the patient in an upright position may provide a maximum WBV therapy. To mitigate falling hazards, the patient may be held onto the table. The patient may be held on the table with one or more of rails, arm supports, belts, and straps. This may be advantageous when administering WBV with the table and the patient being placed in a steep inclined orientation.

The table or bed maybe adjustable to adjust the intensity of WBV. In at least one embodiment, the table may be inclined and reclined via remote control. This hi-lo tilt table capability allows the patient to experience WBV with different levels of gravitational pressure on the vibrating platform, thus adjusting vibrational transference without changing the frequency, and also for some, reducing the motion sickness or dizzying side effects.

A vibrational treatment footplate for administering WBV to the patient may be designed to slide adjust to accommodate appropriate treatment positioning for patients of different heights being treated while resting on the table. The vibrational footplate is configured and disposed to engage the bottom of the patient's feet, vibrate, and provide vibrational treatment, in the form of whole body vibration, to the patient. WBV therapy has been clinically shown to stimulate bone growth, aid in osteocyte regeneration, cellular tissue rejuvenation, increase muscle tone in the lower extremities, and help improve stability and core strengthening.

One or more selected vibrational frequencies may be administered to the musculosketal system of the patient. For example, a sole selected vibrational frequency may be administered to the patient. In as least one other embodiment, two or more vibrational frequencies may be administered to the patient. For example, the treatment footplate may be vibrated at different frequencies at different treatment sessions or during the same treatment session.

In at least one embodiment, the presently disclosed system is configured for the facilitation of combining two modalities, WBV and spinal decompression, which may uniquely treat the disc of the patient for decompression and the musculoskeletal structure concurrently. This combination may provide for an optimal full body and spinal treatment, concurrently. This multiple modality of the presently disclosed system may provide a unique treatment for the patient and a cost effective combination that may improve clinical efficiency and patient flow.

In at least one embodiment, the presently disclosed system may be configured to provide both physiotherapeutic spinal mobilization and decompression modalities. For example, WBV may provide for a substantial portion of physiotherapeutic spinal mobilization and a knee cushion and/or separating portions of the table or bed and/or harnesses or straps, may provide for a substantial portion of spinal decompression.

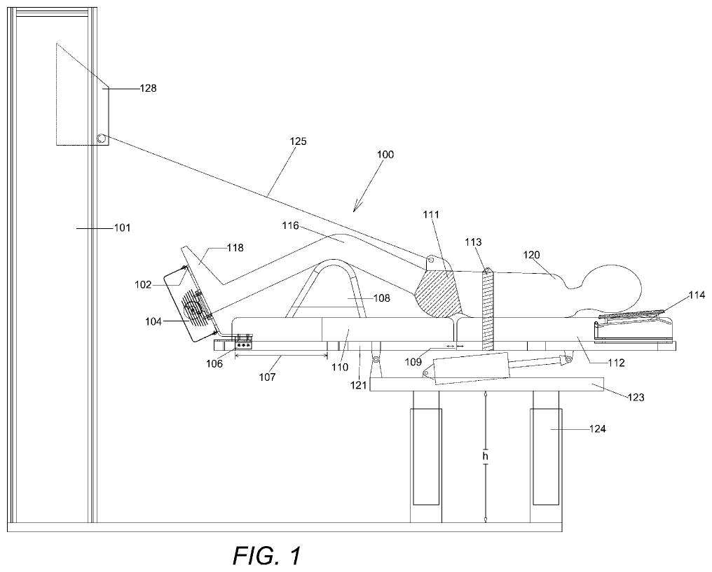

FIGS. 1 through 4 show an illustrative example of the presently disclosed system 100 for providing decompression modalities with linear whole body vibration therapy having a table 121 in varying degree of inclinations. FIG. 1 depicts patient 120 in a substantially horizontal orientation. In FIG. 1, table 121 is orientated in a substantially horizontal orientation which may minimize the gravitational force of patient 120 onto vibrational plate 102 and maximize the gravitional force of patient 120 onto table 121. For example, upon placing table 121 in a substantially horizontal orientation, the force between feet 118 and vibrational plate 102 may be minimized.

The horizontal orientation of table 121 may maximize a decompression therapy. For example, table 121 may comprise a first portion 110 and a second portion 112. First portion 110 and second portion 112 may be separated from one another, as designated with separation 109. Separation 109 may be expanded for spinal decompression. A combination of inclination of table 121, approaching horizontal, and separation 109 may be adjusted to provide a desired degree of spinal decompression. A desired degree of spinal decompression may also be obtained with belt or strap 113 holding the torso of patient 120 to the second portion 112 of table 112 and applying force to pelvic harness 111. For example, pelvic harness 111 may be secured about the pelvis of patient 120 and a tensile force may be placed on tensioner link 125 with decompression head 128. Decompression head 128 is configured and disposed to place tension on tensioner link 125 and to move up and down on riser 101 to provide a desired angle of tension on pelvic harness 111. Knee cushion 108 may be placed under knees 116, which may also aid in providing a desired degree of decompression. Head rest 114 may be positioned on table 121.

WBV may be administered to patient 120 with vibrational plate 102. Vibrational plate 102 may be in communication with motor 104 which may be configured and disposed to vibrate plate 102 at desired frequencies. Vibrational plate 102 may be adjustable. For example, vibrational plate 102 may be mounted to table 121 with slide mount 106. Slide mount 106 may enable vibrational plate 102 to be moved along a length of table 121 as designated with movement arrow 107. The movement of vibrational plate 102 may provide for administration of WBV to patient 120 of various heights and may provide for the adjusting of WBV and/or spinal decompression therapy of patient 120.

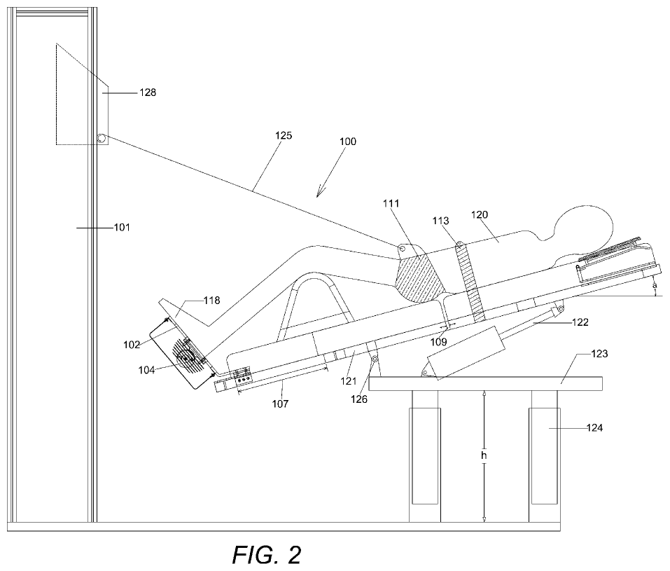

FIG. 2 shows an illustrative example of system 100 for providing decompression modalities with linear WBV therapy having table 121 in a first inclined orientation, angle (a). The first inclined orientation of table 121, as shown in FIG. 2, may provide a desired degree of WBV and/or decompression therapy for patient 120. As table 121 is inclined, or moved toward a vertical orientation, the gravitational force between patient 120 and vibrational plate 102 is increased.

System 100 may have actuator 122 configured and disposed to adjust the inclination of table 121. For example, table 121 may be pivotally held to stand 123 with pivot joint 126. For example, actuator 122 may be extended and retracted to provide a desired inclination of table 121. An increase in the inclination of table 121 may provide for an increase gravitational force between patient 120 and vibrational plate 102, which may result in an increased intensity of WBV of patient 120. For example, as shown in FIG. 2, actuator 122 is extended by an amount sufficient to provide an angle (a) between table 121 and the horizontal orientation.

System 100 may have an adjustable support 124 configured and disposed to adjust a height (h) of stand 123. It may be desired to increase or decrease height (h) for different heights of patient 120. For example, it may be desired to have a greater height (h) for a taller patient 120 and a greater extension of vibrational plate 102, extended about movement arrow 107. In this embodiment, vibrational plate 102 may be placed proximate the floor for easing the mounting of patient 120 onto vibrational plate 102 and table 121, upon table 121 being disposed in a substantially fully inclined orientation.

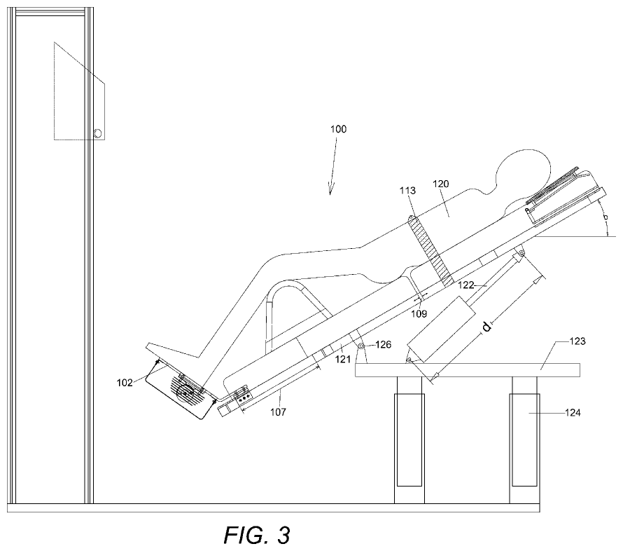

FIG. 3 shows an illustrative example of system 100 for providing decompression modalities with linear WBV therapy having table 121 in a second inclined orientation, angle (b). The second inclined orientation of table 121, as shown in FIG. 3, may provide a desired degree of WBV and/or decompression therapy for patient 120. As table 121 is inclined, or moved toward a vertical orientation, the gravitational force between patient 120 and vibrational plate 102 is increased.

System 100 may have actuator 122 configured and disposed to adjust the inclination of table 121. For example, table 121 may be pivotally held to stand 123 with pivot joint 126. For example, actuator 122 may be extended and retracted, to a length (d), to provide a desired inclination of table 121. An increase in length (d) and the increased inclination of table 121 may provide for an increase gravitational force between patient 120 and vibrational plate 102, which may result in an increased WBV of patient 120 as may be desired. For example, as shown in FIG. 3, actuator 122 is extended by an amount (d) sufficient to provide an angle (b) between table 121 and the horizontal orientation. Optionally, system 100 may have a belt or strap 113 which may mitigate, or substantially eliminate, patient 120 from falling from table 121.

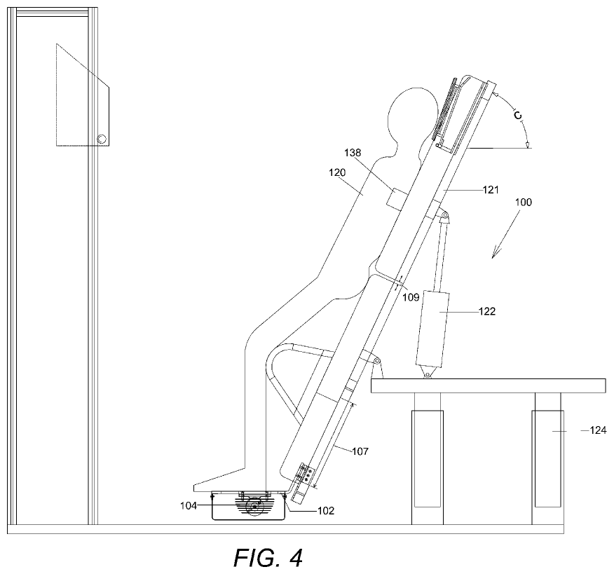

FIG. 4 shows an illustrative example of system 100 for providing decompression modalities with linear WBV therapy having table 121 in a substantially fully inclined orientation, angle (c). The inclined orientation of table 121, as shown in FIG. 4, may provide a desired degree of WBV and/or decompression therapy for patient 120. The inclination of table 121 shown in FIG. 4 is inclined toward, or proximate, a vertical orientation. This orientation may provide an increased gravitational force between patient 120 and vibrational plate 102 and an increased WBV therapy of patient 102. For example, actuator 122 may be extended to provide a desired inclination of table 121, which may become proximate a vertical orientation. For example, as shown in FIG. 4, actuator 122 is substantially fully extended to provide an angle (c) between table 121 and the horizontal orientation. This substantially fully extended actuator 122 may dispose vibrational plate 102 proximate the floor and provide for easy on and off of table 121 for patient 120.

Adjustable support 124 may be adjusted to provide a desired height of table 121. For example, the adjusting of the position of vibrational plate 102 about movement 107 and the adjusting of the height of table 121, with adjustable support 124, vibrational plate 102 may become proximate the floor thus easing the mounting and dismounting of patient 102 onto and off of vibrational plate 102 and table 121.

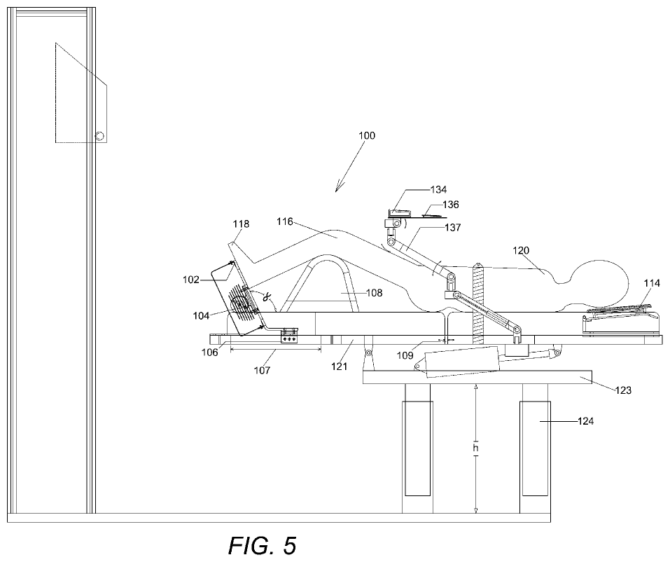

FIG. 5 shows an illustrative example of system controls that may be disposed with the system 100 and an embodiment of an angular disposition of vibrational plate 102. In at least one embodiment of the present disclosure, system 100 has vibration control 134 configured and disposed to control motor 104 for vibrating vibrational plate 102. For example, vibration control 134 may be adapted to control a vibrating frequency of vibrational plate 102, its on/off status, a session timer, or other attributes of motor 104. Control commands may be input with keyboard 136 or remotely with a remote control. The system may be configured to respond to commands such as moving adjustable support 124, tensioning and relaxing tensioner link 125, moving vibrational plate 102 with respect to the longitudinal axis of table 121, expanding and contracting actuator 122, moving decompression head 128, and provide other desired responses to other commands. Keyboard 136 and vibration control 134 may be disposed with articulating arm 137.

Vibrational plate 102 may be configured to be extendably held to table 121 with slide mount 106. Slide mount 106 may enable vibrational plate 102 to be moved along a length of table 121 as designated with movement arrow 107, as shown in FIG. 1. Vibrational plate 102 may be constructed of a material and have a configuration that provides for an efficient transfer of the vibrational force, resulting from its communication with motor 104, to patient 120. For example, vibrational plate 102 may be constructed of a rigid material, such as metal or rigid polymeric material, and may have a desired thickness. Vibrational plate 102 may have an angled portion angular extending upward from table 121 at a desired angle (α). Angle (α) may be any desired angle between, and including, 90° and 180°. For example, angle (α) may be greater than 90° and less than 170° or 120°. Angle (α) may be adjustable or a system 100 may have a variety of vibrational plates with different angles (α). Angle (α) may be adjusted, or selected, to provide a vibrating surface at a desired angle to the legs of patient 120. For example, knee cushion 108 having a desired height for supporting the knees of patient 120 may be selected and a desired angle (α) may be selected to provide a vibrating surface at a desired angle to the legs of patient 120, such as 90°. In at least one embodiment, it may be desired to have a vibrating surface at a substantially perpendicular angle to the lower legs of patient 120.

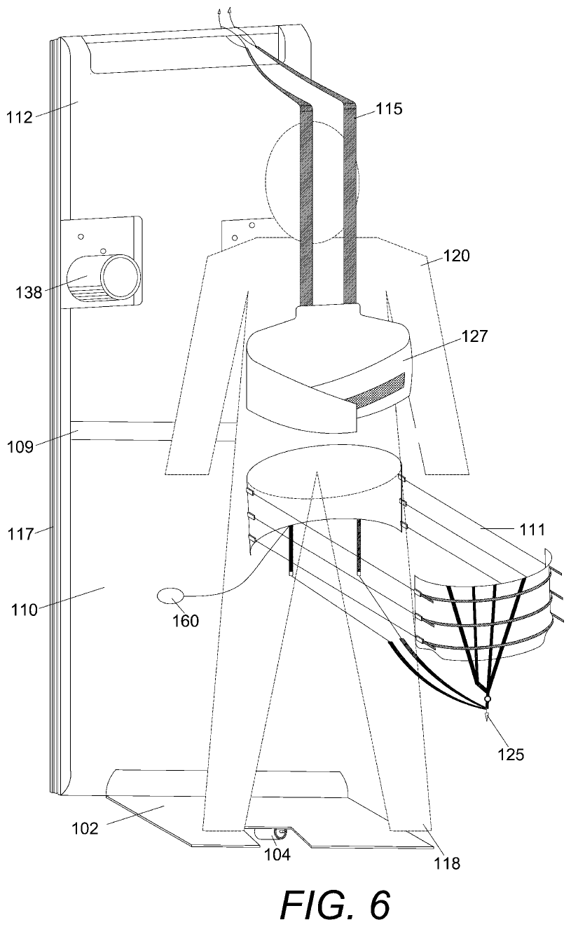

FIG. 6 shows an illustrative example of the presently disclosed system for providing linear whole body vibration therapy and decompression modalities. Upper body harness 127 may be secured about the abdomen of patient 120 and pelvic harness 111 may be secured about the pelvis of patient 120. Tensioner link 125 may extend from pelvic harness 111 and to decompression head 128. Upper body harness 127 may have a strap 115 extending to a head of table 121. Upon tensioner link 125 being tensioned, a spinal decompression force is applied to patient 120. Table 121 may have rails 117 extending along its sides and/or arm supports 138 disposed on its surface for holding patient 120 on table 121. Pelvic harness 111 may have a front and a rear portion and the rear portion may have a bladder that may be expanded with bladder hand pump 160.

The presently disclosed method for providing decompression modalities with linear human body vibration therapy may include standing a patient on a footplate, reclining a table from a substantially vertical orientation to an inclined orientation, and vibrating the footplate, or vibrational plate, and thus providing WBV treatment to the patient. One or more modalities of treatment may be administered to the patient. For example, the footplate may be vibrated at a sole selected frequency, providing one modality of treatment to the patient. Additionally, the footplate may be vibrated at two or more selected frequencies, providing a plurality of modalities of treatment.

The force of the footplate against the bottoms of the patient's feet may be measured and adjusted to provide a desired transfer of vibrational movement to the patient. The degree of inclination of the table, the weight of the patient, and the coefficient of friction of the patient may provide variations in the transfer of vibrational movement from the footplate to the patient.

In at least one embodiment, the footplate measures the force of the patient being applied to the footplate. For example, the footplate may be configured to function as a scale for measuring weight. The inclination of the table may be adjusted to provide for a desired force, or weight, of the patient on the footplate to provide a desired transfer of vibrational movement to the patient.

In at least one embodiment, a method of providing WBV may comprise a series of WBV sessions. For example, a first session may comprise placing the table in a more horizontal orientation. Subsequent sessions may include inclining the table toward a more vertical orientation, thus increasing WBV treatments as the patient becomes more acclimated to the WBV therapy.

One feature or aspect of an embodiment is believed at the time of the filing of this patent application to possibly reside broadly in a method of providing whole body vibration therapy to a patient comprising the steps of: standing the patient on a vibrational footplate extending outward from an inclined oriented table; reclining the table toward a horizontal orientation and stopping the reclining of the table at an angle (a) above horizontal; activating the vibrational footplate and providing whole body vibration to the patient at a first vibrational frequency and for a first period of time; returning the table to the inclined orientation; removing the patient from the vibrational footplate; resting the patient for a period of time; standing the patient back onto the vibrational footplate; reclining the table toward the horizontal orientation and stopping the reclining of the table at an angle (b) above horizontal; activating the vibrational footplate and providing whole body vibration to the patient at a second vibrational frequency and for a second period of time; returning the table to the inclined orientation; and removing the patient from the vibrational footplate.

Another feature or aspect of an embodiment is believed at the time of the filing of this patent application to possibly reside broadly in the method, wherein the angle (b) is greater than the angle (a).

Yet another feature or aspect of an embodiment is believed at the time of the filing of this patent application to possibly reside broadly in the method, wherein the first vibrational frequency is the same as the second vibrational frequency.

Still another feature or aspect of an embodiment is believed at the time of the filing of this patent application to possibly reside broadly in the method, wherein the first period of time is the same as the second period of time.

A further feature or aspect of an embodiment is believed at the time of the filing of this patent application to possibly reside broadly in the method, wherein at least one of the first and the second vibrational frequencies and the first and the second periods of time are different.

Another feature or aspect of an embodiment is believed at the time of the filing of this patent application to possibly reside broadly in the method comprising extending the vibrational footplate outwardly from the table at an angle greater than 90.

Yet another feature or aspect of an embodiment is believed at the time of the filing of this patent application to possibly reside broadly in the method further comprising raising the knees of the patient on the table by an amount sufficient to provide substantially a 90 degree angle between the patient's lower legs and the vibrational footplate.

Still another feature or aspect of an embodiment is believed at the time of the filing of this patent application to possibly reside broadly in the method further comprising inducing a tensional force on the patient's spine, thereby providing spinal decompression to the patient during the whole body vibration therapy.

A further feature or aspect of an embodiment is believed at the time of the filing of this patent application to possibly reside broadly in the method, wherein at least one of the first period of time and the second period of time is between about 5 minutes and 60 minutes.

Another feature or aspect of an embodiment is believed at the time of the filing of this patent application to possibly reside broadly in the method, wherein the resting period of time is at least 1 hour.

Yet another feature or aspect of an embodiment is believed at the time of the filing of this patent application to possibly reside broadly in the method, wherein at least one of the first and the second vibrational frequency is between about 25 Hz and about 50 Hz.

One feature or aspect of an embodiment is believed at the time of the filing of this patent application to possibly reside broadly in the method further comprising holding a torso of the patient to the table.

Another feature or aspect of an embodiment is believed at the time of the filing of this patent application to possibly reside broadly in the method further comprising slide moving the vibrational footplate toward or away from the table, along a longitudinal axis of the table.

Yet another feature or aspect of an embodiment is believed at the time of the filing of this patent application to possibly reside broadly in the method further comprising adjusting a height of the table.

Still another feature or aspect of an embodiment is believed at the time of the filing of this patent application to possibly reside broadly in a whole body vibration system comprising: a table configured to hold a patient; a vibrational footplate extending from a foot of the table and outwardly from a plane of the table at an angle between about 90 degrees and about 170 degrees; the vibrational footplate being configured and disposed to vibrate and to provide whole body vibration to the patient upon the patient placing their feet thereon; and an actuator configured and disposed to adjust an inclination of the table.

A further feature or aspect of an embodiment is believed at the time of the filing of this patent application to possibly reside broadly in the whole body vibration system further comprising a knee support configured and disposed to raise the patient's knees from the table by an amount sufficient to provide substantially a 90 degree angle between the patient's lower legs and the vibrational footplate.

Another feature or aspect of an embodiment is believed at the time of the filing of this patent application to possibly reside broadly in the whole body vibration further comprising a belt or other device configured and disposed to hold a torso of the patient on the table.

Yet another feature or aspect of an embodiment is believed at the time of the filing of this patent application to possibly reside broadly in the whole body vibration system further comprising a pelvic harness configured and disposed to hold a pelvis of the patient and induce a tensional force on the patient's spine.

Still another feature or aspect of an embodiment is believed at the time of the filing of this patent application to possibly reside broadly in the whole body vibration system, wherein the table comprises a first portion and a second portion and the system is configured to move the first and the second portion of the table apart and to induce a tensional force on the patient's spine.

A further feature or aspect of an embodiment is believed at the time of the filing of this patent application to possibly reside broadly in the whole body vibration system further comprising a footplate adjusting mechanism configured and disposed for adjusting the vibrational footplate toward or away from the table, along a longitudinal axis of the table.

Another feature or aspect of an embodiment is believed at the time of the filing of this patent application to possibly reside broadly in a whole body vibration and spinal decompression system comprising: a table configured to hold a patient; a vibrational footplate extending from a foot of the table and outwardly from a plane of the table at an angle between about 90 degrees and about 170 degrees; the vibrational footplate being configured and disposed to vibrate and to provide whole body vibration to the patient upon the patient placing their feet thereon; an actuator configured and disposed to adjust an inclination of the table; a belt, upper body harness, or other device configured and disposed to hold a torso of the patient with respect to the table; a pelvic harness configured and disposed to hold a pelvis of the patient; and a decompression head configured and disposed to apply tension to the pelvic harness, and thereby the spine of the patient, and decompress the patient's spine.

### NOMENCLATURE

whole body vibration system 100

riser 101

vibrational plate 102

motor 104

slide mount 106

movement arrow 107

knee cushion 108

separation 109

a first portion 110

pelvic harness 111

second portion 112

belt or strap 113

head rest 114

strap 115

knees 116

rail 117

feet 118

patient 120

table 121

actuator 122

stand 123

adjustable support 124

tensioner link 125

pivot joint 126

upper body harness 127

decompression head 128

vibrational control 134

keyboard 136

articulating arm 137

arm supports 138

bladder hand pump 160

angle α

angle a

angle b

angle c

height h

length d

It will be understood that the examples of patents, published patent applications, and other documents which are included below in this application and which are referred to in paragraphs which state “Some examples of . . . which may possibly be used in at least one possible embodiment of the present application . . . ” may possibly not be used or useable in any one or more embodiments of the application. These references, or portions thereof, are hereby incorporated by reference herein. The purpose of incorporating U.S. patents, foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

Some examples of features which may possibly be utilizable by at least one possible embodiment may possibly be found in the following which are incorporated by reference herein: U.S. Pat. No. 8,079,971, titled “Spinal Mobilization Treatment System with Multi-Dimensional Force Application”, filed 2009 May 29, by Carlos Becerra; U.S. Pat. No. 6,152,950, titled “Apparatus for Therapeutic Treatment of Low Back Pain”, filed 1998 Mar. 31, by Norman et al.; U.S. Ser. No. 15/627,870, titled “Spine Alignment And Decompression Systems”, by Sepulveda, Homero, filed 2017 June 2020; and US 20140018712, titled “Vibrating Massage Table” by Bouchet and Pageot, filed 2014 January 2016.

1. A method of providing whole body vibration therapy to a patient comprising the steps of:
standing the patient on a vibrational footplate extending outward from an inclined oriented table;
reclining the table toward a horizontal orientation and stopping the reclining of the table at an angle (a) above horizontal;
activating the vibrational footplate and providing whole body vibration to the patient at a first vibrational frequency and for a first period of time;
returning the table to the inclined orientation;
removing the patient from the vibrational footplate;
resting the patient for a period of time;
standing the patient back onto the vibrational footplate;
reclining the table toward the horizontal orientation and stopping the reclining of the table at an angle (b) above horizontal;
activating the vibrational footplate and providing whole body vibration to the patient at a second vibrational frequency and for a second period of time;
returning the table to the inclined orientation; and
removing the patient from the vibrational footplate.

2. The method of claim 1, wherein the angle (b) is greater than the angle (a).

3. The method of claim 1, wherein the first vibrational frequency is the same as the second vibrational frequency.

4. The method of claim 1, wherein the first period of time is the same as the second period of time.

5. The method of claim 1, wherein at least one of the first and the second vibrational frequencies and the first and the second periods of time are different.

6. The method of claim 1 comprising extending the vibrational footplate outwardly from the table at an angle greater than 90.

7. The method of claim 6, further comprising raising the knees of the patient on the table by an amount sufficient to provide substantially a 90 degree angle between the patient's lower legs and the vibrational footplate.

8. The method of claim 1, further comprising inducing a tensional force on the patient's spine, thereby providing spinal decompression to the patient during the whole body vibration therapy.

9. The method of claim 1, further comprising holding a torso of the patient to the table.

10. The method of claim 1, further comprising slide moving the vibrational footplate toward or away from the table, along a longitudinal axis of the table.

11. The method of claim 1, further comprising at least one of the limitations of a) through d), wherein a) through d) are:
a) at least one of the first and the second vibrational frequency is between about 25 Hz and about 50 Hz;
b) a step of adjusting a height of the table;
c) at least one of the first period of time and the second period of time is between about 5 minutes and 60 minutes; and
d) the resting period of time is at least 1 hour.

12. A whole body vibration and spinal decompression system comprising:
a table configured to hold a patient;
a vibrational footplate extending from a foot of the table and outwardly from a plane of the table at an angle between about 90 degrees and about 170 degrees;
the vibrational footplate being configured and disposed to vibrate and to provide whole body vibration to the patient upon the patient placing their feet thereon;
an actuator configured and disposed to adjust an inclination of the table;
a belt, upper body harness, or other device configured and disposed to hold a torso of the patient with respect to the table;
a pelvic harness configured and disposed to hold a pelvis of the patient; and
a decompression head configured and disposed to apply tension to the pelvic harness, and thereby the spine of the patient, and decompress the patient's spine.

13. The whole body vibration and spinal decompression system of claim 12, wherein the table comprises a first portion and a second portion, the vibrational footplate extends from the first portion and the belt, upper body harness, or other device is configured and disposed to hold the torso of the patient to the second portion of the table, and the system is configured to move the first and the second portion of the table apart and to induce a tensional force on the patient's spine.

14. The whole body vibration and spinal decompression system of claim 12, further comprising a footplate adjusting mechanism configured and disposed for adjusting the vibrational footplate toward or away from the table, along a longitudinal axis of the table.

15. A whole body vibration system comprising:
a table configured to hold a patient;
a vibrational footplate extending from a foot of the table and outwardly from a plane of the table at an angle between about 90 degrees and about 170 degrees;
the vibrational footplate being configured and disposed to vibrate and to provide whole body vibration to the patient upon the patient placing their feet thereon; and
an actuator configured and disposed to adjust an inclination of the table.

16. The whole body vibration system of claim 15, further comprising a knee support configured and disposed to raise the patient's knees from the table by an amount sufficient to provide substantially a 90 degree angle between the patient's lower legs and the vibrational footplate.

17. The whole body vibration system of claim 15, further comprising a belt or other device configured and disposed to hold a torso of the patient on the table.

18. The whole body vibration system of claim 17, further comprising a pelvic harness configured and disposed to hold a pelvis of the patient and induce a tensional force on the patient's spine.

19. The whole body vibration system of claim 17, wherein the table comprises a first portion and a second portion and the system is configured to move the first and the second portion of the table apart and to induce a tensional force on the patient's spine.

20. The whole body vibration system of claim 15, further comprising a footplate adjusting mechanism configured and disposed for adjusting the vibrational footplate toward or away from the table, along a longitudinal axis of the table.
